(19) United States
(12) Patent Application Publication
(10) Pub. No.: US 2013/0224722 A1
(43) Pub. Date: Aug. 29, 2013

(54) SYSTEM AND METHOD OF SELECTIVELY REMOVABLE WRITING TABLETS

(71) Applicant: FASTENation, Inc., (US)

(72) Inventor: David Petak, Clifton, NJ (US)

(73) Assignee: FASTENATION, INC., Clifton, NJ (US)

(21) Appl. No.: 13/775,483

(22) Filed: Feb. 25, 2013

Related U.S. Application Data
(60) Provisional application No. 61/603,136, filed on Feb. 24, 2012.

(51) Int. Cl. B43L 1/00

(52) U.S. Cl. CPC B43L 1/00
USPC 434/408

(57) ABSTRACT

A system for attaching at least one writing tablet to a surface configured to receive the writing tablet, including a backing element and a tablet element. The backing element and tablet elements each comprise at least one surface with an array of touch fastening elements allowing the backing element and tablet element to be removably engageable to one another. At least one surface of the tablet element may comprise a surface allowing a user to draw or write on the surface in a dry or wet erase manner.

### CROSS REFERENCE TO RELATED APPLICATIONS

This application claims the benefit of priority under 35 U.S.C. §119(e) to U.S. Provisional Application No. 61/603,136, filed Feb. 24, 2012, titled “System and Method of Selectively Removable Writing Tablets” hereby incorporated by reference in its entirety.

### BACKGROUND OF THE INVENTION

1. Field of the Invention

The present invention generally relates to systems and methods of selectively removable touch fastener writing tablets, and their use.

2. Description of Related Art

There are many commercial, industrial, and residential applications involving a need for a writing surface that is attachable, portable, writable, both dry and wet erasable and able to provide a stable and supportive connection when affixed, yet the desired product remains unavailable. Additionally, there is a need for the product to be re-usable, disposable, and re-positionable. By way of example, in garment applications, it is often desired to have a name tag that can be affixed to the garment, but removable for cleaning or washing of the garment. It is also desired to be able to easily change the name on the garments name tag. Presently, name tags are either permanently stitched onto worker uniforms and require the same name to be fixed to the same uniform. The present invention seeks to create an easy to use, re-usable, re-positionable, and portable product that alleviates the above inadequacies of the prior art. The present invention has applications to improve the prior art in the printing industry, garment industry, hospitality industry, medical industry, educational industry, and manufacturing industry, among others.

### SUMMARY OF THE INVENTION

In general, one embodiment of the invention relates to a system for attaching at least one writing tablet to a surface configured to receive the writing tablet. The system comprises a backing element and a tablet element. The backing element and tablet elements each comprise at least one surface with an array of touch fastening elements allowing the backing element and tablet element to be removably engageable to one another. At least one surface of the tablet element may comprise a surface allowing a user to draw or write on the surface in a dry or wet erase manner.

In another embodiment the invention relates to a strap system for attaching at least one writing tablet, and in some embodiments, a plurality of writing tablets to a surface configured to receive the writing element(s). This system comprises a buckle and attachment element for attaching the buckle to a backing element. The backing element and a tablet element each comprise at least one surface with an array of touch fastening elements allowing the backing element and tablet element to be removably engageable to one another. In some embodiments, the strap system lacks a buckle and instead connects to itself or other strap systems through its arrays of touch fastening elements. In this embodiment, the backing element is a strap configured to receive a plurality of tablet elements, each of which may be drawn or written on, either while detached from the backing element, or while in a mating engageable configuration with the backing element. In this embodiment, the strap system further comprises an extension element further comprising at least one surface with an array of touch fastening elements allowing the extension element to be removably engageable with either the touch fastening elements of its same strap, or touch fastening elements of a separate strap, for attachment in a linked fashion. At least one surface of the extension element allows the user to draw or write on the surface in a dry or wet erase manner.

In another embodiment, the backing element may comprise a second surface configured for attachment to a garment or container, for purposes of labeling or itemizing the garment or container. The attaching surface configured for receiving the backing element may comprise another array of touch fastening elements, or may be attached in some other manner, such as adhesion or bonding.

### BRIEF DESCRIPTION OF THE DRAWINGS

Certain embodiments in the present invention will be better understood when read in conjunction with the appended drawings wherein like reference numerals refer to like components. For the purposes of illustrating the device of the present application, there is shown in the drawings preferred embodiments. It should be understood, however, that the application is not limited to the precise arrangement, structures, features, embodiments, aspects, and devices shown, and the arrangements, structures, features, embodiments, aspects and devices shown may be used singularly or in combination with other arrangements, structures, features, embodiments, aspects and devices. The drawings are not necessarily drawn to scale and are not in any way intended to limit the scope of this invention, but merely to clarify a single illustrated embodiment of the invention. In the drawings:

FIG. 1(a) is a front view of an embodiment comprising a touch fastener backing element with corresponding writing tablet element;

FIG. 1(b) is a front view of the embodiment of FIG. 1(a) where the writing tablet element is removed from the backing element;

FIG. 2(a) is a front view of a buckle portion of an embodiment comprising a strap form of touch fastener backing element with a plurality of corresponding writing tablet elements;

FIG. 2(b) is a front view of an extension element portion of FIG. 2(a) comprising a strap form of touch fastener backing element with a plurality of corresponding writing tablet elements; and

FIG. 3 is a front view of an embodiment of a writing tablet as used in a name-tag application.

### DETAILED DESCRIPTION OF THE INVENTION

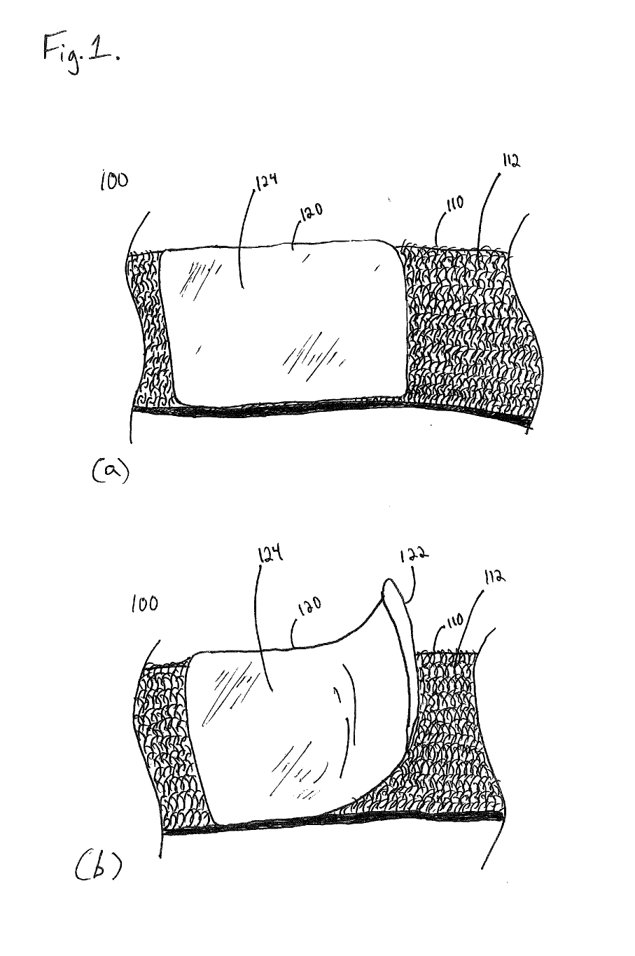

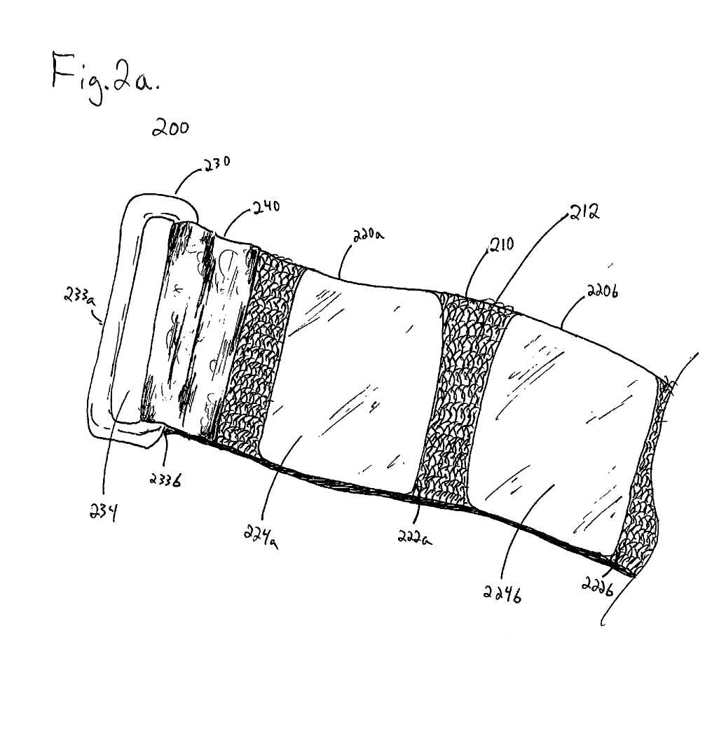

As illustrated in FIGS. 1(a)-(b), one embodiment of the removable tablet system (100) comprises a backing element (110) and a tablet element (120). In this embodiment, the backing element (110) and tablet element (120) are selectively connectable and removable from one another. In particular, the backing element (110) and tablet element (120) may each comprise at least one surface capable of mating with one another to provide a system where the backing and tablet elements (110, 120) are releasably engageable with one another without tools to create the closure or engagement.

As illustrated in FIGS. 1(a)-(b), one embodiment of the removable tablet system (100) comprises a backing element (110) and a tablet element (120) where the two elements are engaged via a touch fastening system. Accordingly, at least one surface (112) of the backing element (110) comprises an array of touch fastening elements. At least one surface of the tablet element (122) comprises an array of touch fastening elements configured for mating with the touch fastening elements of the backing element (112). This mating engagement between the backing element (110) and tablet element (120) may be by way of male and female touch fastening elements such as a hook and loop fastening system. This mating engagement may also be by way of male to male touch fastening elements where male touch fastening elements interlock with each other to form a closure. Additionally, the arrays of touch fastening elements of the backing and/or tablet element (110, 120) may comprise combinations of male and female touch fastening elements, such as an OMNI-TAPE® product or similar. With hook and loop touch fastening elements, the hook and loop configurations may be either woven, formed, or made via any other suitable method of manufacture. Furthermore, any other form of touch fastening element suitable for removably engaging the backing element (110) and tablet element (120) may be used, such as by pressure sensitive adhesive backing, foam type, or Dual Lock™ fasteners, among others. The touch fasteners are configured to be re-usable and re-positionable.

In this embodiment, the tablet element (120) may comprise at least two surfaces with one surface (122) comprising an array of touch fastening elements configured for removable mating engagement with the touch fastening elements of the backing element (112), and the other surface (124) comprising a smooth (non-touch fastening) surface configured for writing or drawing applications with a suitable writing or drawing utensil. The tablet element (120) may be made of a polypropylene material and may include laminate coating on at least one side. Preferably, the surface configured for writing (124) may be the laminated surface. In some embodiments, the lamination process may incorporate two different kinds of adhesives. In this embodiment, the tablet element (120) may be configured for both wet and dry erase material applications (i.e., erasure with either a tissue or sponge), depending on the type of writing utensil used. In this embodiment, the tablet element (120) is intended to be both writable and erasable.

In some embodiments, the tablet element (120) may be configured to be substantially the same size and shape as the backing element (110). The tablet element (120) and backing element (110), when connected, may be either free standing or connected to some other object, including another backing element (110) with its own touch fastening elements (not shown). For example, the backing element (110) could also be woven onto a uniform, or may also comprise a second surface of touch fastening elements for selectable engagement to a clothing item or household item, such as a container, for labeling. In the present embodiment, the tablet element (120) may be of a white color, but any other color suitable for the selected application may be utilized. Additionally, the tablet element (120) may be configured with a hologram, reflective, X-ray detectable, RFID, bar coding, or any shape or pattern suitable for the selected application.

The backing element (110) and tablet element (120) may be a variety of shapes, depending upon the application. As shown in FIGS. 1(a)-(b), the tablet element (120) is substantially rectangular, with rounded edges. Also as shown in FIGS. 1(a)-(b), the backing element (110) is substantially rectangular, and of generally the same shape as the tablet element (120), although as shown, slightly oversized from the tablet element (120). In manufacturing, the backing element (110) and tablet element (120) may be made by specific die-cut shapes, appropriate for various applications (i.e., circle, square, rectangle, triangle, star, heart, balloon, etc.). The backing element (110) may be manufactured from materials generally suitable for touch fastening applications such as hook and loop fasteners. The tablet elements (120) may be manufactured to connect the array of touch fastening elements on one side (122) to a polypropylene surface on the other side (124) with a Seal Rite® material, polypropylene material, or other suitable material with similar properties.

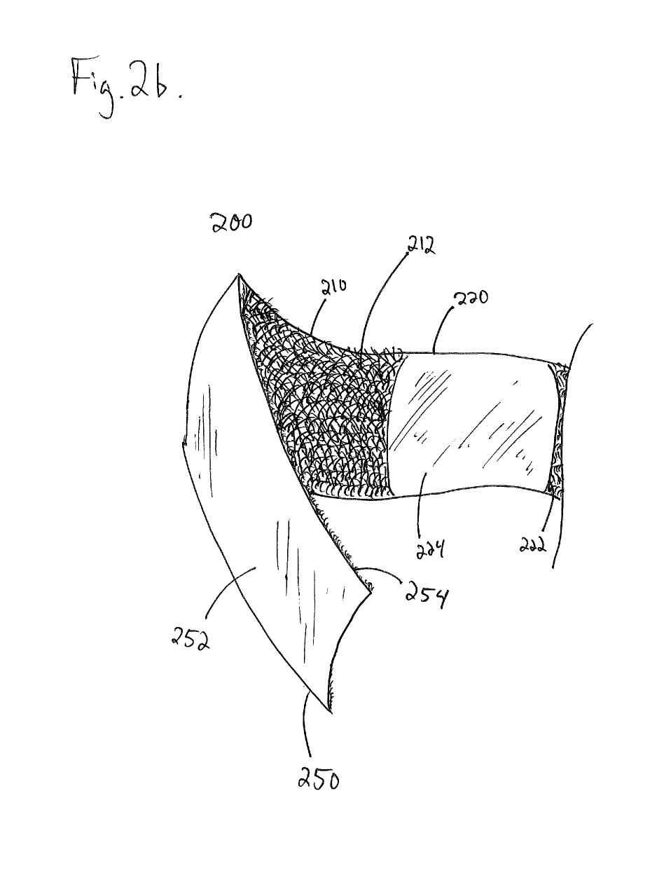

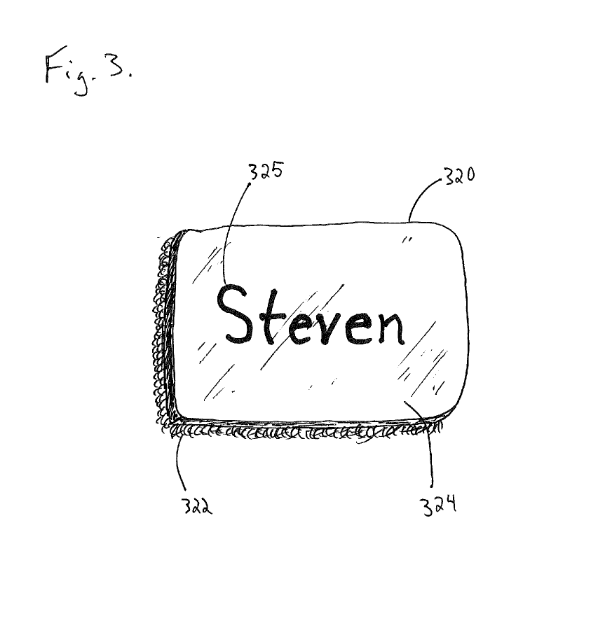

As illustrated in FIG. 2(a), one embodiment of the removable tablet system (200) comprises a backing element (210) and a plurality of tablet elements (220a, 220b) where the backing element (210) is configured in a strap format. In this embodiment, the backing element (210) comprises an elongated strap with an array of touch fastening elements on at least one side (212). In this embodiment a plurality of tablet elements (220a, 220b) are selectively connectable and removable from the backing element (210).

The removable tablet system (200) of FIG. 2 may also comprise a buckle feature (230) and attachment portion (240). The buckle (230) may be any form of rectangular or curved rim that when attached to the backing element (210) strap, the strap is able to fasten that end to another part of the strap or a different strap. The buckle (230) may alternatively be configured to couple a second interlocking buckle (not shown) at another part of the strap. The buckle (230) comprises a first leg (233a) and second leg (233b) configured to define an opening (234), sized to receive an attachment portion (240) or the backing element (210) strap. The buckle (230) may be formed, cast, or otherwise constructed from any suitably rigid material.

The buckle (230) may be attached to the backing element (210) strap by way of an attachment portion (240). The attachment portion (240) may comprise any material capable of holding or forming touch fastening elements. In other embodiments, the strap may lack a buckle, and instead connect to itself or other straps via touch fastening elements.

The backing element (210) strap may be an in an elongated shape, and be configured to removably mate with a plurality of tablet elements (220a, 220b). In some embodiments, the backing element (210) may be configured with touch fastening elements on both sides of the backing element (210) in order to receive tablet elements (220a, 220b) on both sides of the backing element (210). In this embodiment, the backing element (210) may also be configured to mate with a second backing element strap (not shown) with corresponding arrays of touch fastening elements. In some embodiments, the backing element (210) strap may be a rigid material, a synthetic or cloth-like material, or may be a stretchable material. In addition to the at least one tablet element (220), some embodiments may include an adjustable pad (not shown) that fits slidably, or fixed, along the strap.

In some embodiments, the strap may be any of a cinch-style strap, a reverse strap, an adjustable strap, a face strap, or a strap system customized to the needs of the specific application. In some embodiments, the strap and/or touch fastener materials may be made of a stretchable material. In some embodiments, the strap and/or touch fastener materials may be made of a non-slip material.

In some embodiments, the plurality of tablet elements (220a, 220b) may be a substantially rectangular shape, as shown in FIG. 2a, or may be any other shape suitable for the desired application. The tablet element (220) may also comprise a single strap-like configuration, intended to mate with the backing element (210) strap. In this embodiment, the tablet element (220) strap may be substantially the same size, shape and length as the backing element (210) strap. In this embodiment, the surface of the tablet element (224) intended for writing or drawing may be a portion of the tablet element strap or the entire tablet element strap.

FIG. 2(b) illustrates a re-usable, re-positionable, write-on touch fastening strap system (200) of FIG. 2(a) with a backing element (210) and at least one tablet element (220), where the system further comprises an extension element (250). In this embodiment, the extension element (250) is an elongated element and has a first surface (252) and a second surface (254). The first surface (252) comprises a smooth (non-touch fastening) surface configured for writing or drawing applications with a suitable writing or drawing utensil. The second surface (254) comprises an array of touch fastening elements configured for removable mating engagement with the touch fastening elements of the same strap or a separate strap (not shown). The second surface (254) provides the function of allowing the strap to either wrap around and attach onto its own backing element (210) thus providing a securable cinching strap connection, or allowing the strap to connect to a separate strap in a linking fashion. In one embodiment of the configuration of the extension element (250) attaching onto its same strap, the touch fastening elements of the second surface (254) attach to the touch fastening surfaces of the backing element (210) of the same strap. In one embodiment of the strap attaching to other straps in a linking fashion (not shown), the touch fastening elements of the second surface (254) of the extension element (250) attach to the touch fastening elements of the other straps. In this embodiment, the extension element (250) may also engage with a buckle of the other straps (not shown) to provide a securing or cinching function.

In one embodiment, the extension element (250) may be connected to either surface of the backing element (210) by means of sewing, bonding, laminating, or other appropriate means. The extension element (250) may be any suitable length and shape, and may comprise any suitable array of touch fastening elements on its second surface (254). In some embodiments, the extension element (250) may be the same length as the entire strap or backing element (210) it is attached to.

The extension element (250) may be made of a polypropylene material and may include laminate coating on at least one side. Preferably, the first surface (252), the surface configured for writing, may be the laminated surface. In some embodiments, the lamination process may incorporate two different kinds of adhesives. In this embodiment, the first surface (252) may be configured for both wet and dry erase material applications (i.e., erasure with either a tissue or sponge), depending on the type of writing utensil used. In this embodiment, the first surface (252) is intended to be both writable and erasable. Additionally, the extension element (250) may be of a white color, but any other color suitable for the selected application may be utilized. Additionally, the first surface (252) may be configured with a hologram, reflective, X-ray detectable, RFID, bar coding, or any shape or pattern suitable for the selected application. The write-on feature of the extension element (250) allows for every area of the strap system to be covered by some form of tablet and written on. This even includes the buckle portion (230) when the extension element (250) folds over the buckle (230) and attaches to the backing element (210).

FIG. 3 illustrates the tablet element (320) as used in a writing application, showing an optionally laminated front surface (324), and portion of a touch fastening element rear surface (322), where a user has removed the tablet from a backing element and written on the tablet (325). The user, if desired, may also write or draw on the tablet while the tablet is removably affixed to the backing element.

Embodiments of the invention are envisioned in a variety of industries. Cinching straps or other styles of write-on touch fastener systems may be used in the signage and printing industries for stabilizing and labeling bundle rolls of media (e.g., paper, vinyl, canvas, foils), graphics or blueprints. Cinching straps or other styles of write-on touch fastener systems may also be used in the textile industry to bundle and label rolls of fabric, or may be sewn or bonded onto the fabric for identification purposes. In the hospitality industry, write-on touch fasteners may be bonded to food containers for labeling, or strap touch fasteners may be used to bundle and label linens and tablecloths. In the medical industry, write-on touch fasteners may be used for stable and secure chart placement and cinching straps may be used to label and bundle cables, wires, tubing and oxygen or air lines of machinery in patient rooms and operating rooms. They may also be used to label hospital machinery in operating rooms. Write-on touch fasteners may also be used in the orthotics and physical therapy areas. In a medical setting, it may be highly advantageously to utilize re-usable and disposable (e.g., single patient use) write-on touch fastening elements. In educational and special needs industries, teaching aids and teaching devices can utilize write-on touch fastening technology. In the inventory and manufacturing industries, warehouses can utilize re-usable, re-positionable write-on touch fastening element technology to label and keep track of bins, racks and inventory. Additionally, industries can use write-on touch fasteners for OSHA and safety notifications in order to see the status of a machine or factory area.

As such, those skilled in the art will appreciate that the conception, upon which this disclosure is based, may readily be utilized as a basis for the designing of other structures, methods and systems for carrying out the several purposes of the present invention. It is important, therefore, that the invention be regarded as including equivalent constructions to those described herein insofar as they do not depart from the spirit and scope of the present invention.

For example, the specific sequence of the described process may be altered so that certain processes are conducted in parallel or independent, with other processes, to the extent that the processes are not dependent upon each other. Thus, the specific order of steps and/or functions described herein is not to be considered implying a specific sequence of steps to perform the process. Other alterations or modifications of the above processes are also contemplated.

In addition, features illustrated or described as part of one embodiment can be used on other embodiments to yield a still further embodiment. Additionally, certain features may be interchanged with similar devices or features not mentioned yet which perform the same or similar functions. It is therefore intended that such modifications and variations are included within the totality of the present invention.

Although the present invention has been described and illustrated in the foregoing exemplary embodiments, it is understood that the present disclosure has been made only by way of example, and that numerous changes in the details of implementation of the invention may be made without departing from the spirit and scope of the invention.

What is claimed is:

1. A removable tablet system, comprising:
a tablet element and a backing element, wherein the tablet element and the backing element are removably engageable with one another;
wherein the tablet element comprises a first surface and a second surface, the first surface comprising a fastener surface and the second surface comprising a laminated surface;
wherein the first surface is attached to the tablet element with an adhesive material; and
wherein the backing element has at least a first surface, the first surface comprising a fastener surface.

2. The removable tablet system of claim 1, wherein the fastening surface comprises a hook and loop fastener array.

3. The removable tablet system of claim 1, wherein the adhesive material is polypropylene.

4. The removable tablet system of claim 1, wherein the adhesive material is a Seal Rite® material.

5. The removable tablet system of claim 1, wherein the second surface of the tablet element is configured for writing, and allows dry or wet erase functionality.

6. The removable tablet system of claim 1, wherein the backing element comprises a strap.

7. The removable tablet system of claim 6, wherein the strap further comprises an extension element wherein at least one surface of the extension element comprises a fastener surface.

8. The removable tablet system of claim 1, wherein the backing element further comprises a buckle.

9. The removable tablet system of claim 1, wherein the system comprises a plurality of tablet elements.

10. A method of using a removable tablet system, comprising:
providing a removable tablet system, including a tablet element and a backing element, wherein the tablet element and the backing element are removably engageable with one another, and wherein the backing element further comprises a strap;
engaging the strap to a buckle or other strap;
writing on the tablet element;
erasing the writing from the tablet element; and
removing the tablet element from the backing element or fastening the tablet element to the backing element.
